(19) United States
(12) Patent Application Publication
(10) Pub. No.: US 2009/0039326 A1
(43) Pub. Date: Feb. 12, 2009

(54) Device for guiding an aerial rope of a mechanical lift installation comprising means for automatic stopping of the installation

(75) Inventors: Thierry Triolier, Voiron (FR); Laurent Bonifat, La Buisse (FR)

Correspondence Address: OLIFF & BERRIDGE, PLC, P.O. BOX 320850, ALEXANDRIA, VA, 22320-4850, US

(73) Assignee: POMAGALSKI SA., Fontaine (FR)

(21) Appl. No.: 12/216,771

(22) Filed: Jul. 10, 2008

(30) Foreign Application Priority Data
Aug. 10, 2007 (FR) 07 05820

(51) Int. Cl. B66D 3/04

(52) U.S. Cl. 254/391

(57) ABSTRACT

A device for guiding an aerial rope of a mechanical lift installation in which said rope, driven by a driving pulley set in motion by a drive motor, is equipped with roller sheaves for guiding the rope, mounted rotating on a support frame. Each guiding roller sheave comprises a sheave body delineating an annular groove at its periphery and a band with a high friction coefficient housed in the groove of the sheave body. The device comprises, associated with at least one of said sheaves, automatic detection means of a predefined wear threshold of the band of said associated sheave, and means for automatic stopping of said drive motor when said threshold is detected. The automatic detection means are formed by an electrically conducting element electrically insulated with respect to the sheave assembly and connected to the latter by fixing means in a transverse position where the rope automatically comes into contact with said element when the band of the associated sheave reaches the predefined wear threshold.

### BACKGROUND OF THE INVENTION

The invention relates to a device for guiding an aerial rope of a mechanical lift installation in which said rope is driven by a driving pulley set in motion by a drive motor, said device comprising a sheave assembly equipped with roller sheaves for guiding the rope, mounted rotating on a support frame along axes of rotation staggered along the support frame in a longitudinal direction of the sheave assembly parallel to the direction of the rope, each guiding roller sheave comprising:
a sheave body delineating an annular groove at its periphery,
a band with a high friction coefficient housed in the groove of the sheave body.

The device comprises, associated with at least one of said sheaves, automatic detection means of a predefined threshold of wear of the band of said associated sheave, and automatic stopping means of said drive motor when said threshold is detected.

### STATE OF THE ART

In mechanical lift installations of the chair-lift or gondola car type, the aerial rope is guided and secured on each pylon by a guiding device comprising a bottom sheave assembly with roller sheaves for supporting and guiding the rope when the latter runs on the line and/or by a top sheave assembly with compression and guiding roller sheaves. A mixed sheave assembly comprises both a bottom sheave assembly and a top sheave assembly. These different combinations of sheave assemblies constitute different variants of rope pressing and guiding sheave assemblies. The invention relates to supervision of such sheave assemblies, whatever the variant.

The pylons are located between the loading and unloading terminals of the installation. Chairs and/or cars are fixed to the rope by means of fixed or detachable grips. The roller sheaves of the sheave assembly are generally associated in pairs and are fitted on the ends of primary beams articulated in their middle part on the ends of secondary beams, themselves fitted in the same way on tertiary beams, and so on depending on the number of sheaves. The last beam is mounted articulated in its middle part on a post of the bearing structure of the pylon. These elementary (primary, secondary, tertiary etc. . . . ) sheave assemblies together form a support frame of the sheave assembly

A sheave is conventionally composed of a sheave body provided with a central bore for fitting a rotation spindle connected to the sheave assembly support frame. The sheave body delineates an annular groove, at its periphery, housing a band with a high friction coefficient designed to guide the rope laterally when the latter runs on the line.

For a pressing and guiding sheave assembly, whatever the variant of the embodiment (bottom, top or mixed), when the sheaves rotate, running of the rope causes wear of the sheave bands therefore requiring them to be replaced after a certain operating time. The state of wear of the bands is checked with a predefined frequency imposed by administrative regulations. In the course of checking, if the band presents sufficient wear, it has to be replaced, if not the same operation has to be repeated after an additional operating time.

In parallel with this normal wear of the bands, there is a perpetual risk during use of a sheave assembly of at least one of the roller sheaves blocking in rotation for some reason or other. In such an exceptional situation, the running movement of the rope with respect to the blocked sheave causes very rapid wear of the band housed in the groove of the sheave body: degradation of the band is localized solely at the place of the band where friction with the rope takes place and the speed with which degradation of the band occurs is much greater than in the case of normal use. This therefore results in a very large risk of the band of the sheave blocked in rotation wearing over its whole thickness at the place where friction with the rope occurs before the next normal periodical checking operation performed by the maintenance personnel. In this case, the rope will in return cause damage to the body of the blocked sheave, which will cause irreversible and dangerous wear of the rope itself. Such a risk is not satisfactory for the operators, either as far as the cost of replacing the damaged parts or as far as the general safety of the mechanical lift installation are concerned.

The document EP0771709 describes a guiding device equipped with means for automatic detection of movement of the rope in an associated sheave with respect to a normal position of the rope. This movement can result from strong side winds or from wear of the band of the sheave. In case of movement reaching a predefined value compared with the normal position, cut-off means connected to the detection means stop the running of the rope. Automatic detection is performed by analyzing an output voltage signal of a magnetoelectric converter placed in a magnetic field generated between the rope and a magnetic source located under the converter. The converter output is connected to an automatic power cutoff electric circuit. The detection means are therefore achieved remotely, without contact with the rope or mechanical action, by electromagnetic means implementing a magnetic source under the rope generating a magnetic flux directed towards the rope, and a magnetoelectric converter fitted between the rope and the magnetic source.

But detection depends solely on the magnetic flux measured in continuous manner by the magnetoelectric converter. But the field, and therefore the value of its flux, may be subject to external disturbances or may vary due to problems at the level of the magnetic source. For example the magnetic flux may decrease in case of demagnetization of the permanent magnet when the magnetic source is formed by a permanent magnet. This results in the magnetic flux being able to undergo variations independent from those due to changes of the position really occupied by the rope. Reliability of detection is therefore not maximum due to lack of direct correlation with the physical position of the rope: the wear threshold may be falsely detected even though the rope has not yet actually reached the position corresponding to the wear threshold of the band or, on the contrary, the wear threshold may not be detected even though the rope has actually reached the position corresponding to the wear threshold of the band.

### OBJECT OF THE INVENTION

The object of the invention consists in providing a guiding device that does not present the drawbacks of the prior art, and which in particular provides enhanced safety and reliability.

The device according to the invention is remarkable in that the automatic detection means are formed by an electrically conducting element electrically insulated with respect to the sheave assembly and connected to the latter by fixing means in a transverse position where the rope comes automatically into contact with said element when the band of the associated sheave reaches the predefined wear threshold.

The object of the invention is to use the electric potential change (grounding) of the electrically conducting element directly caused by mechanical contact between the latter and the rope, which mechanical contact occurs automatically (on account of the transverse position of the electrically conducting element) when the wear threshold of the band is reached. This results in absolute reliability of detection, the means being electromechanical.

When the predefined wear threshold is detected by the detection means associated with a roller sheave blocked in rotation due to the mechanical contact of the rope, the stopping means associated with this same sheave automatically cause cutoff of the drive motor. This results in the running movement of the rope with respect to the band of the blocked sheave being stopped. This automatic operation of these two types of means therefore causes stopping of the rope well before the sheave body of the blocked sheave and the rope itself are damaged.

Other technical features can be used alone or in combination:
the electrically conducting element presents a general funnel shape open at the longitudinal ends and having a flat bottom and two raised side edges convergent in the direction of the bottom,
the flat bottom is inclined in the longitudinal direction,
the automatic stopping means comprise an electric terminal electrically connected to the electrically conducting element and performing connection of a spade connector fixed to one end of an electrically conducting wire the other end of which wire is connected to an electric system that cuts the power supply to the drive motor when the rope comes into contact with said electrically conducting element,
the fixing means comprise an electrically conducting metallic transverse foot welded to the electrically conducting element and fixed onto a support plate mounted on a transverse beam fixed to the sheave assembly, fixing of the transverse foot being performed by means of bolts in association with nuts, a first electrically insulating washer being fitted between the support plate and the transverse foot and a second electrically insulating washer being fitted between the foot and bolt heads,
the electrically conducting element is arranged in the mid-plane of the body of the associated sheave.

### BRIEF DESCRIPTION OF THE DRAWINGS

Other advantages and features will become more clearly apparent from the following description of a particular embodiment of the invention given for non-restrictive example purposes only and represented in the accompanying drawings, in which:

FIG. 1 represents an example of a guiding device according to the invention, in side view of a lateral cross-section at the level of a roller sheave,

FIG. 2 represents a part of the device of FIG. 1 in front view,

FIG. 3 is a side view of the device of the previous figures,

FIG. 4 is a top view of the part of device illustrated in FIG. 2,

FIG. 5 illustrates the device of the previous figures along the discontinuous transverse cross-sectional plane A-A of FIG. 2.

### DESCRIPTION OF A PREFERRED EMBODIMENT OF THE INVENTION

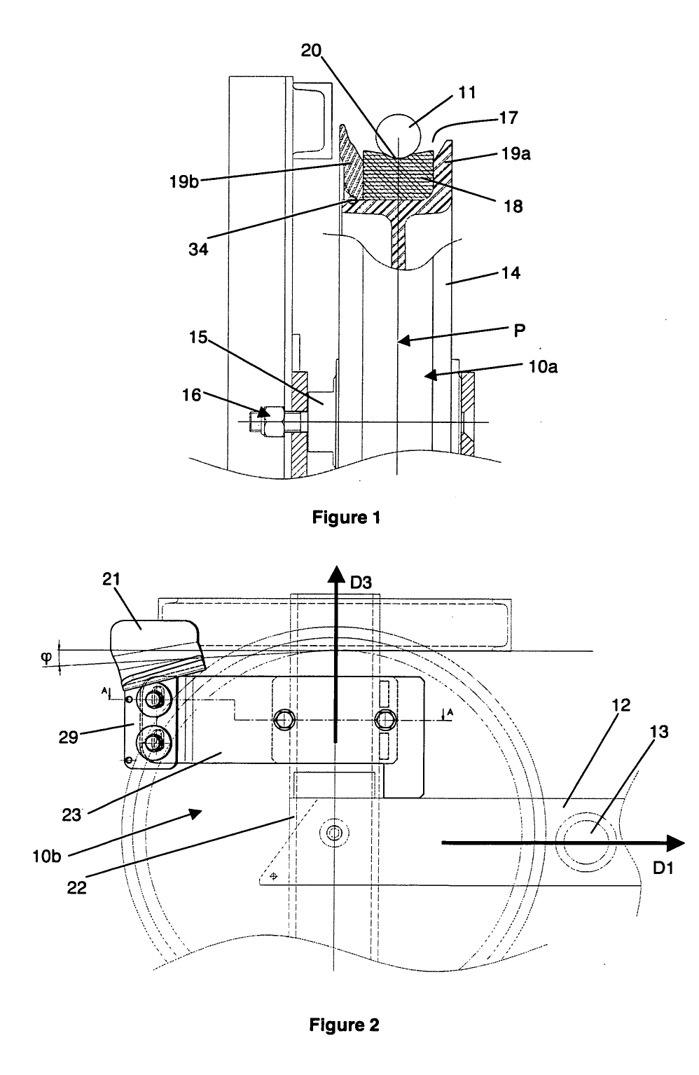

FIGS. 1 to 5 illustrate an example of a guiding device of an aerial rope 11 of a mechanical lift installation according to the invention. The guiding device comprises a pressing and guiding sheave assembly of the rope 11 as described below. FIG. 1 illustrates a lateral cross-section of a first roller sheave 10a of the pressing and guiding sheave assembly. FIGS. 2 to 5 represent a second roller sheave 10b of the sheave assembly, identical to first sheave 10a. Sheaves 10a, 10b are mounted on the ends of a primary beam 12. Second sheave 10b is arranged up-hill from first sheave 10a in the direction of running of rope 11. Primary beam 12 is articulated in the middle-part thereof on the ends of a secondary beam (not shown). Primary beam 12 is mounted swivelling freely around a swivel-pin 13 of cylindrical shape securedly affixed to the secondary beam by any suitable fixing means such as a nut and bolt system. The secondary beam is itself fitted in the same way on a tertiary beam (not shown), and so on depending on the number of sheaves. The last beam is mounted articulated in the mid-part thereof on a post of a bearing structure (not shown) of the pylon.

The set of elementary beams of the sheave assembly (primary 12, secondary, tertiary etc. . . . ) forms the sheave assembly support frame. Primary beam 12 represented therefore only constitutes a part of the support frame. In this way, like sheaves 10a, 10b, the set of roller sheaves (variable in number according to the number of elementary beams) of the sheave assembly are mounted rotating on the support frame with parallel axes of rotation staggered along the support frame in a longitudinal direction D1 (see arrow of FIG. 2) of the sheave assembly that is parallel to the direction of rope 11.

In conventional manner in a mechanical lift installation, rope 11 on which the vehicles (cars, chairs) transporting the passengers of the installation are suspended is driven by a driving pulley housed in a terminal and set in motion by an electric drive motor (not shown).

The pressing and guiding sheave assembly partially represented in FIGS. 1 to 5 is a bottom sheave assembly: the two guiding roller sheaves 10a, 10b represented are therefore roller sheaves for support and guiding of rope 11. Indifferently, the rest of the description can be adapted to the case of a top pressing and guiding sheave assembly equipped with roller sheaves for compression and guiding of the rope.

In FIG. 1, sheave 10a comprises a sheave body 14 comprising a central bore in which a rotation spindle 15 of sheave 10a is mounted securedly affixed to primary beam 12 by a nut and bolt system 16. Sheave body 14 is mounted rotating loose around the rotation spindle 15 by means of a set of bearings, for example of the ball-bearing type or other.

Sheave body 14 delineates an annular groove presenting a substantially U-shape 17 at the peripheral part thereof. A band 18 with a high friction coefficient is housed inside groove 17 to guide rope 11 laterally during its running when sheave 10a rotates.

Groove 17 is delineated by a first edge 19a constituting the end of sheave body 14 and by a second edge 19b arranged facing the pylon and remaining fixed to sheave body 14 when sheave 10a is dismantled to replace band 18. A flexible washer 34 solidly secures the connection between second edge 19b of groove 17 and band 18.

Band 18 is made of polymer material, preferably rubber or other elastomer material, and fills the whole width of groove 17 of sheave body 14. Band 18 preferably comprises a tread 20 over the whole periphery of band 18 designed to follow the shape of rope 11 when the latter positions itself on band 18 and when it runs around sheave 10a.

In conventional manner, sheave 10a comprises an indicator ring (not shown) inserted in the heart of band 18 and acting as visual indicating means of the wear of band 18. In this way, when the indicator ring is apparent at the top surface of band 18, this means that the whole thickness of band 18 situated above the ring has been worn by the various frictions of the rope and that band 18 and/or sheave 10a have to be replaced.

Band 18 is achieved for example by winding successive strips of rubber inside groove 17. The indicator ring is inserted between two successive strips of rubber and dissimulated in the heart of band 18.

Such a sheave 10a equipped with an indicator ring inserted in the heart of band 18 thereby enables it to be seen quickly at a single glance whether a level of wear of band 18 has been exceeded or not, so that dismantling of sheave 10a is only performed when replacement of band 18 is necessary.

Guiding device, only a part of which is represented in FIGS. 2 and 4, is further equipped with automatic detection means of a predefined wear threshold of band 18 of roller sheave 10b. In other words, the automatic detection means are associated with roller sheave 10b to automatically detect that band 18 of this sheave 10b has reached a predefined wear threshold. Such means are to be differentiated from the indicator ring inserted in band 18 of sheave 10b. The indicator ring merely enables a maintenance technician to make a visual check of whether a predefined level of wear (according to the positioning of the ring in the thickness of band 18) has been exceeded or not, when performing his maintenance operations. The indicator ring does not perform any detection function. On the contrary, such automatic detection means themselves perform detection of a predefined wear threshold. Moreover, the wear threshold that the detection means are designed to detect can be very different from the wear level which results in visual appearance of the indicator ring. In particular, the wear threshold designed to be detected by the detection means corresponds to a state of wear of band 18 that is much more advanced than when the indicator ring becomes visually apparent.

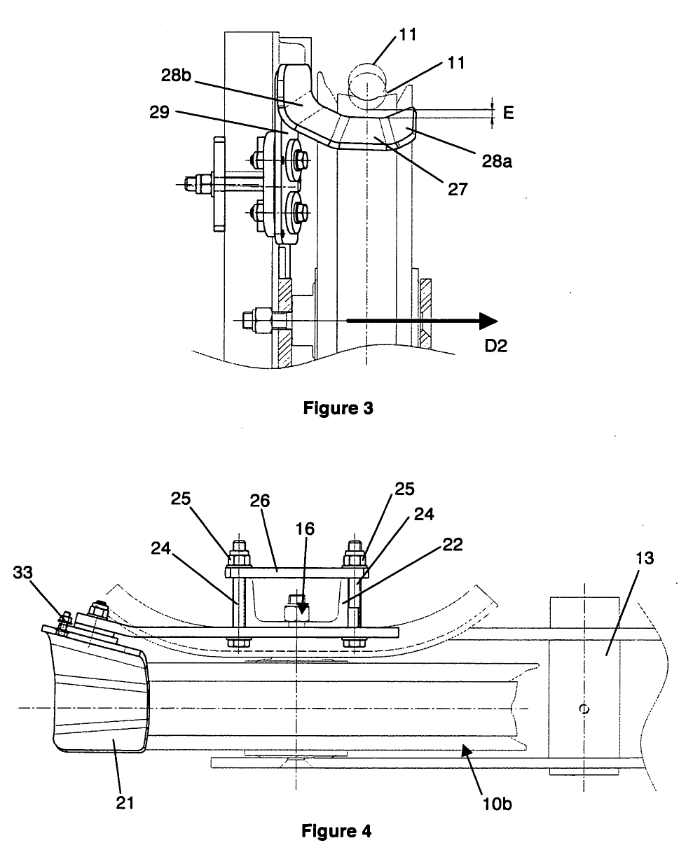

In the example described, the detection means are formed by an electrically conducting element 21 arranged longitudinally (in the longitudinal direction D1) along rope 11, arranged laterally (in a lateral direction D2) in mid-plane P of sheave body 14 of sheave 10b associated with these detection means, and arranged transversally (in a transverse direction D3) in a transverse position where rope 11 comes automatically into contact with said element 21 when band 18 of associated sheave 10b reaches the predefined wear threshold. Lateral direction D2 of the sheave assembly is parallel to the axes of rotation of the set of roller sheaves of the sheave assembly, in particular parallel to the axes of rotation of sheaves 10a, 10b (see arrow in FIG. 3). The direction perpendicular to longitudinal direction D1 and to lateral direction D2 corresponds to the transverse direction D3 of the sheave assembly (see arrow in FIG. 2). Such an electrically conducting element 21 can be built-in when the sheave assembly is constructed by means of permanent fixing means, or it can be added onto the sheave assembly by any suitable removable fixing means. In all cases, the fixing means ensure electric insulation of conducting element 21 with respect to the sheave assembly.

In FIGS. 2 to 5, electrically conducting element 21 is an add-on part fixed above primary beam 12 of the sheave assembly by removable fixing means comprising a transverse beam 22 of U-shaped cross-section fixedly mounted on the sheave assembly at the end of primary beam 12 on which sheave 10b is fitted. Transverse beam 22 is perpendicular to primary beam 12 and parallel to mid-plane P of sheave body 14 of sheave 10b. Transverse beam 22 is fixed by means of nut and bolt system 16 also performing fixing of rotation spindle 15.

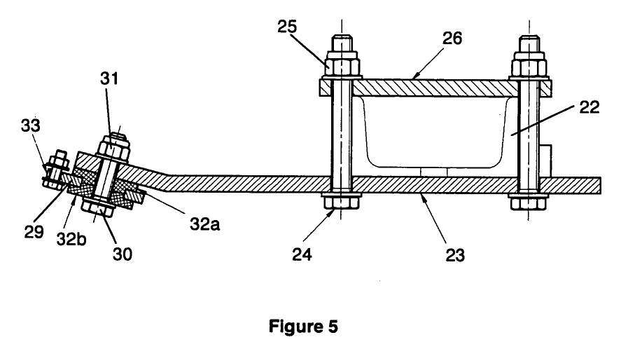

The fixing means further comprise a support plate 23 fitted along transverse beam 22 to extend in a direction parallel to mid-plane P in the up-hill direction (with respect to the direction of running of rope 11) of sheave 10b in the direction D1. Fixing of support plate 23 on transverse beam 22 is performed by means of two fixing bolts 24 and two nuts 25 associated therewith. Fixing bolts 24 extend in the lateral direction D2 and are arranged on each side of transverse beam 22. Tightening of nuts 25 fitted on fixing bolts 24 clamps transverse beam 22 between support plate 23 and a counter-plate 26 (see FIGS. 4 and 5).

With reference to the figures, electrically conducting element 21 presents a general funnel shape open at the longitudinal ends and having a flat bottom 27 and two raised side edges 28a, 28b convergent in the direction of the bottom 27. Side edge 28b is the one that is arranged on the side where transverse beam 22 is located. Flat bottom 27 is inclined in the longitudinal direction D1 of the sheave assembly. In other words flat bottom 27 approaches rope 11 approaching associated roller sheave 10b: the longitudinal end of element 21 nearest to rotation spindle 15 in the longitudinal direction D1 is nearer to rope 11 in the transverse direction D3 than the opposite longitudinal end of element 21. The space E separating 11 and the longitudinal end of element 21 nearest to rotation spindle 15 in the longitudinal direction D1 determines the value of the predefined wear threshold. Adjustment of the space E is made by adjusting the transverse position of electrically conducting element 21. This transverse positioning has to take the possible angle of deviation φ of rope 11 into account, which angle must always be less than 3.5° (see FIG. 2). FIG. 3 represents space E measured from rope 11 when the latter presents a maximum angle of deviation cp. FIG. 3 also illustrates the lateral cross-section of rope 11 when the rope does not present any deviation φ.

Electrically conducting element 21 is fixed to support plate 23 by means of a transverse metallic foot 29 one end of which is welded to side edge 28b. Fixing of transverse metallic foot 29 to support plate 23 is performed by means of two bolts 30 associated with two nuts 31. FIG. 5 illustrates this fixing in greater detail. A first electrically insulating washer 32a is inserted between support plate 23 and transverse metallic foot 29 and a second electrically insulating washer 32b is inserted between transverse metallic foot 29 and the head of the bolts 30.

FIG. 5 also illustrates that transverse metallic foot 29 is provided with an electric terminal 33. Electric terminal 33 is thus electrically connected to electrically conducting element 21 by means of transverse metallic foot 29 and welding of foot 29 onto element 21 which are both electrically conducting. Electric terminal 33 performs connection of a spade connector (not shown) fixed to one end of an electrically conducting wire the other end of which is connected to an electric system which cuts the power supply of the drive motor when rope 11 comes into contact with electrically conducting element 21. The electric system cutting the power supply of the motor for example comprises an electromechanical or electronic relay placed in the control part of the drive motor and designed to transmit a cutoff order of its electric power supply to the power part if element 21 is grounded. This grounding is caused by contact of rope 11 with element 21. Such an electric system can be arranged near to the sheave assembly or near the drive motor. Moreover, a given electric system can be associated with a plurality of electrically conducting elements 21.

Consequently, when roller sheave 10b blocks in rotation during a sufficiently long time for the running movement of rope 11 to cause local wear of its band 18 such that rope 11 moves transversely by a value greater than space E, rope 11 comes into contact with the longitudinal end of electrically conducting element 21 that is nearest to rotation spindle 15. In this case, the predefined wear threshold is automatically detected by electrically conducting element 21. By this contact with rope 11, electrically conducting element 21 is grounded. The electric system (to which element 21 is connected by means of transverse metallic foot 29, the welding, electric terminal 33, spade connector and the wire connected to the spade connector) notes this change of electric potential of element 21 and automatically causes shut-down of the drive motor by cutting its electric power supply. This results in the running movement of rope 11 with respect to band 18 of blocked sheave 10b being stopped. This automatic operation therefore causes rope 11 to be stopped well before damage is caused to body 14 of sheave 10b in the blocked state and to rope 11 itself, in a totally reliable manner by the use of purely electromechanical means triggered by mechanical contact of rope 11.

The previously described pressing and guiding sheave assembly, combined with electrically conducting element 21 and with the electric system to which it is electrically connected, constitute an example embodiment of a guiding device of aerial rope 11 according to the invention, i.e. a guiding device using roller sheaves and which comprises automatic detection means, associated with at least one of said sheaves, of a predefined wear threshold of the band of said associated sheave, and automatic stopping means of the drive motor of rope 11 when said threshold is detected. Within this guiding device, the automatic detection means are formed by electrically conducting element 21 whereas the automatic stopping means are formed by the electric system performing cutting of the power supply to the drive motor and by electric connection between electrically conducting element 21 and said electric system.

Although the detection means described above are only associated with roller sheave 10b, it is possible to provide for electrically conducting element 21 to be associated at the same time with sheaves 10a and 10b. In this case, the electrically conducting element will be positioned longitudinally between roller sheaves 10a and 10b so as to be able to detect independently that one or the other of bands 18 of these two associated sheaves 10a, 10b has reached the predefined wear threshold.

The invention is not limited to the embodiment described here-above. In particular other suitable automatic stopping means can be used. In particular the electric system may be any system provided that it fulfils the function of cutoff of the electric power supply when the electrically conducting element is electrically grounded by contact with the rope.

The reliability of the guiding device is therefore good, for blocking of one of its sheaves causes the running movement of rope 11 to be interrupted well before body 14 of blocked sheave 10b and rope 11 are damaged. This results in a concomitant safety of the installation that is enhanced.

1. A device for guiding an aerial rope of a mechanical lift installation in which said rope is driven by a driving pulley set in motion by a drive motor, said device comprising a sheave assembly equipped with roller sheaves for guiding the rope, mounted rotating on a support frame along axes of rotation staggered along the support frame in a longitudinal direction of the sheave assembly parallel to the direction of the rope, each guiding roller sheave comprising a sheave body delineating an annular groove at its periphery, and a band with a high friction coefficient housed in the groove of the sheave body,
a device comprising automatic detection means, associated with at least one of said sheaves, of a predefined wear threshold of the band of said associated sheave, and automatic stopping means of said drive motor when said threshold is detected,
a device wherein the automatic detection means are formed by an electrically conducting element electrically insulated with respect to the sheave assembly and connected to the latter by fixing means in a transverse position where the rope comes automatically into contact with said element when the band of the associated sheave reaches the predefined wear threshold.

2. The device according to claim 1, wherein the electrically conducting element presents a general funnel shape open at the longitudinal ends and having a flat bottom and two raised side edges convergent in the direction of the bottom.

3. The device according to claim 2, wherein the flat bottom is inclined in the longitudinal direction of the sheave assembly.

4. The device according to claim 1, wherein the automatic stopping means comprise an electric terminal electrically connected to the electrically conducting element and performing connection of a spade connector fixed to one end of an electrically conducting wire the other end of which is connected to an electric system performing cutoff of the power supply of the drive motor when the rope comes into contact with said electrically conducting element.

5. The device according to claim 1, wherein the fixing means comprise an electrically conducting transverse metallic foot welded to the electrically conducting element and fixed on a support plate mounted on a transverse beam fixed to the sheave assembly, fixing of the transverse foot being performed by means of bolts associated with nuts, a first electrically insulating washer being inserted between the support plate and the transverse foot and a second electrically insulating washer being inserted between the foot and the head of the bolts.

6. The device according to claim 1, wherein the electrically conducting element is arranged in the mid-plane of the body of the associated sheave.
